(19) United States
(12) Patent Application Publication
(10) Pub. No.: US 2022/0135045 A1
(43) Pub. Date: May 5, 2022

(54) ROAD SURFACE TYPE ESTIMATION METHOD, ROAD SURFACE TYPE ESTIMATION DEVICE AND VEHICLE CONTROL SYSTEM

(71) Applicant: TOYOTA JIDOSHA KABUSHIKI KAISHA, Toyota-shi (JP)

(72) Inventor: Ryochi WATANABE, Toyota-shi (JP)

(73) Assignee: TOYOTA JIDOSHA KABUSHIKI KAISHA, Toyota-shi (JP)

(21) Appl. No.: 17/489,135

(22) Filed: Sep. 29, 2021

(30) Foreign Application Priority Data
Nov. 2, 2020 (JP) 2020-183721

(51) Int. Cl. B60W 40/076; B60T 8/172

(52) U.S. Cl. CPC B60W 40/076; B60T 8/172; B60W 2420/42; B60W 2552/15; B60W 2520/28; B60T 2210/12

(57) ABSTRACT

Processing to estimate a type of a road surface is executed repeatedly. In the m-th processing, a holding time of an estimation result obtained by the m-th processing is set based on gradient data just before the m-th processing. The holding time is set to a longer duration as an uplink gradient of the road surface indicated by the latest gradient data increases. In the (m+n)-th processing, it is determined whether or not a feature portion is recognized from an imaging data. If this determination result is negative, the holding time is compared with a UNDEF period during which it has been determined that no feature portion has been recognized backward from the (m+n)-th processing. If the holding time is longer than the UNDEF period, then the estimation result obtained in the (m+n)-th processing is assumed to be the same as that obtained in the m-th processing.

### CROSS-REFERENCE TO RELATED APPLICATION

The present application claims priority under 35 U.S.C. § 119 to Japanese Patent Application No. 2020-183721, filed Nov. 2, 2020, the contents of which application are incorporated herein by reference in their entirety.

### TECHNICAL FIELD

The present disclosure relates to a method and a device for estimating a type of a road surface on which a vehicle travels (hereinafter also referred to as a “traveling road surface”), and a system for controlling a travel of the vehicle based on the result of the estimation.

### BACKGROUND

JP2019-175020A discloses a device that determines the type of the traveling road surface and a state of the traveling road surface based on image data taken by a front camera. This conventional device specifically performs the type determination as to whether or not the traveling road surface is paved based on a color, reflected light, etc. in the shot image. This conventional device also determines whether or not the traveling road surface is wet based on the color, reflected light, etc. in the shot image.

The conventional device further sets a changeable range of an area on which the vehicle travels based on type determination and the result of the state determination. This changeable range is set on both left and right sides in a width direction of the vehicle. For example, if the determination result is obtained that the traveling road surface is a dry pavement, the changeable range is set to a first region. If the determination result is obtained that the traveling road surface is a wet pavement, the changeable range is set to a second region being narrower than the first region.

### SUMMARY

The conventional device assume that the front camera continues to take the image of the traveling road surface at all times. However, while traveling an upward slope, information amount of the traveling road surface taken by the front camera decreases toward an end point of the upward slope. In particular, if a gradient of this upward slope is large, the information amount of a feature portion included in the shot image decreases extremely. Then, the type determination result may not be obtained. Therefore, improvements are required to provide the type determination result even in such a case.

Examples of the above improvements include a method in which a previous result of the type determination is diverted when no determination result is obtained. However, it is also assumed a case where the reason why the type determination result is not obtained is a failure including a deviation of an optical axis of the front camera. Therefore, the method simply diverting the previous result of the type determination may not be appropriate from a viewpoint of ensuring an accuracy of the type determination

One objective of the present disclosure is to provide a technique capable of providing an appropriate determination result even when determination result of the type of the traveling road surface based on the shot image of the front camera is not available. Another object of the present disclosure is to provide a technique capable of detecting a defect including the optical axis deviation of the front camera.

A first aspect of the present disclosure is a road surface type estimation method for estimating a type of a road surface on which a vehicle travels, and has the following features.

The road surface type estimation method comprises the steps of:

periodically acquiring imaging data in front of the vehicle and gradient data of the road surface; and

repeating to execute estimation processing to estimate the type of the road surface based on the imaging data.

In m-th time (m≥1) of the estimation processing, a holding time of an estimation result that was obtained in the estimation processing of m-th time is set based on preceding gradient data indicating gradient data acquired just before the execution of the m-th time estimation processing. The larger an uplink gradient of the road surface indicated by the preceding gradient data, the longer the holding time is set.

In the estimation processing of (m+n)-th time (m+n≥2),

it is determined whether or not a feature portion has been recognized from the imaging data;

if it is determined that the feature portion has not been recognized, the holding time is compared with arr unrecognized duration during which it has been continuously determined that the feature portion was not recognized backward from the execution of the (m+n)-th estimation processing; and

if the holding time is longer than the unrecognized duration, it is presumed that the estimation result in the execution of the (m+n)-th estimation processing is the same as that in the execution of the m-th estimation processing.

A second aspect of the present disclosure further has the following features in the first aspect.

The road surface type estimation method further comprises the step of periodically obtaining a wheel speed data of the vehicle.

In the m-th estimation processing, as driving speed of the vehicle indicated by the wheel speed data acquired just before the execution of the m-th estimation processing is higher, the holding time that was set based on the uplink gradient is changed to a shorter duration.

A third aspect of the present disclosure further has the following features in the first aspect.

In the (m+n)-th estimation processing, if the holding time is shorter than the unrecognized duration, failure determination processing is further executed to determine a failure of a. front camera that is configured to acquire the image data periodically.

In the failure determination processing,

a rate of change in a gradient of the road surface is calculated based on a. history of the gradient data that was obtained in a predetermined period backing just before the execution of the (m+n)-th estimation processing; and

if the rate of change is less than a threshold, it is determined that the front camera has failed.

A fourth aspect of the present disclosure is a road surface type estimation device for estimating a type of a road surface on which a vehicle travels, and has the following features.

The road surface type estimation device includes a memory and a processor. The memory is configured to periodically store imaging data in front of the vehicle and gradient data of the road surface. The processor is configured to execute continuously estimation processing to estimate the type of the road surface based on the imaging data.

In the estimation processing of m-th time (m≥1), the processor is configured to set a holding time of an estimation result that was obtained in the m-th estimation processing based on immediately preceding gradient data indicating gradient data stored in the memory just before the execution of the m-th estimation processing. e, the larger an uplink gradient of the road surface indicated by the preceding gradient data, the longer the holding time is set.

In the estimation processing of (m+n)-th time (m+n≥2), the processor is configured to:

determine whether or not a feature portion has been recognized from the imaging data;

if it is determined that the feature portion is not recognized, compere the holding time with an unrecognized duration during which it has been continuously determined that the feature portion was not recognized backward from the execution of the (m+n)-th estimation processing; and if the holding time is longer than the unrecognized duration, estimate that the estimation result in the execution of the (m+n)-th estimation processing is the same as that in the execution of the m-th estimation processing.

A fifth aspect of the present disclosure further has the following features in the fourth aspect.

The memory is further configured to periodically store wheel speed data of the vehicle.

In the m-th estimation processing, the processor is configured to change the holding time that was set based on the uplink gradient to a shorter duration as driving speed of the vehicle indicated by the wheel speed data acquired just before the execution of the m-th estimation processing is higher.

A sixth aspect of the present disclosure further has the following features in the fourth aspect.

The road surface type estimation device further comprises a front camera. which is configured to acquire the imaging data periodically.

In the (m+n)-th estimation processing, the processor is further configured to execute failure determination processing to determine a failure of the front camera if the holding time is less than the unrecognized duration.

In the failure determination processing, the processor is configured to:

calculate a rate of change in a gradient of the road surface based on a history of the gradient data that was obtained in a predetermined period just before the execution of the (m+n)-th estimation processing; and

if the rate of change is less than a threshold, determine that the front camera has failed.

A seventh aspect of the present disclosure is a vehicle control system comprising the road surface type estimation device according to the fourth aspect, and has the following features.

The vehicle control system further comprises a brake device which is configured to apply a braking force to wheels of the vehicle.

The processor is further configured to switch an operation mode of the brake device among a plurality of preset operation modes in accordance with. the estimation result that was obtained in the (m+n)-th estimation processing,

According to the first or fourth aspect, the holding time as a validity period of the estimation result that was obtained by the execution of the m-th estimation processing (m≥1) is set based on the gradient data stored in the memory just before the execution of the m-th estimation processing (i.e., previous gradient data). Specifically, the holding time is set to a longer period as the uplink gradient of the road surface indicated by the preceding gradient data increases, In addition, according to the first or fourth aspect, when it is determined in the (m+n)-th (m+n≥2) estimation processing that the feature portion is not recognized from the imaging data, the holding time is compared with the unrecognized duration. The unrecognized duration is a period during which it has been continuously determined that the feature portion was not recognized backward from the execution of the (m+n)-th estimation processing. Then, if the holding time is longer than the unrecognized duration, it is presumed that the estimation result of the (m+n)-th estimation processing is the same that in the execution of the m-th estimation processing. Therefore, even when it is determined that the feature portion is not recognized, an appropriate estimation result can be given to the type of the traveling road surface on which the vehicle travels currently.

According to the second or fifth aspect, the holding time that was set based on the previous gradient data is changed based on the wheel speed data stored in the memory just before the execution of the m-th estimation processing. Specifically, the holding period is changed to a shorter period as the driving speed of the vehicle indicated by the wheel speed data is higher. This is because, when the vehicle travels at high speed, a situation where it is determined that the feature portion is not recognized is solved quickly as compared with the case in which the vehicle travels at low speed. Therefore, according to the second or fifth aspect, a more appropriate estimation result can be given to type of the traveling road surface on which the vehicle travels currently.

According to the third or sixth aspect, when it is determined in the (m+n)-th estimation processing that the unrecognized duration is longer than the holding time, the failure determination processing is executed. According to the failure determination processing, the rate of change in the gradient of the road surface is calculated based on the history of the gradient data obtained in the predetermined time period backing just before the (m+n)-th estimation processing. And if the rate of change is less than the threshold, it is determined that the front camera has failed. Therefore, according to the third or sixth aspect, it is possible to detect that the reason why the feature portion is not recognized is an occurrence of a defect including the optical axis deviation of the front camera.

In a vehicle control system in which an operation mode of a brake device is set according to the estimation result of the (m+n)-th estimation processing, when it is determined that the feature portion is not recognized, the operation mode may be set to an operation mode different from the operation mode that should be set normally. In this respect, according to the fourth aspect, even when it is determined that the feature portion is not recognized, the appropriate estimation result can be given to the type of the traveling road surface on which the vehicle travels currently. Therefore, according to the seventh aspect based on the fourth aspect, it is possible to suppress feeling of strangeness on a driver of the vehicle due to the setting of the operation mode different from the operation mode that should be set normally.

### BRIEF DESCRIPTION OF DRAWINGS

FIG. 1 is a diagram showing a configuration example of a vehicle control system including a road surface type estimation device according to a first embodiment;

FIG. 2 is a diagram showing a functional configuration example of the controller shown in FIG. 1;

FIG. 3 is a flowchart showing a flow of road surface type estimation processing;

FIG. 4 is a diagram for explaining features of the first embodiment;

FIG. 5 is a diagram showing a relationship example between a gradient ΔG and a holding time T1;

FIG. 6 is a diagram showing a relationship example between driving speed Vv and a correction coefficient C1;

FIG. 7 is a flowchart showing a flow of road surface type estimation processing;

FIG. 8 is a diagram showing a functional configuration example of a road surface type estimation device according to a second embodiment;

FIG. 9 is a diagram for explaining characteristics of the second embodiment; and.

FIG. 10 is a flowchart showing a flow of failure determination processing.

### DESCRITION OF EMBODIMENT

Hereinafter, embodiments of the present disclosure will be described referring to the drawings. Note that a road surface type estimation method according to the embodiments is realized by computer processing executed in a road surface type estimation device according to the embodiments. It should be noted that the same signs are attached to the same elements in the respective drawings, and duplicate descriptions are omitted. Further, the present disclosure is not limited by the following embodiments.

### 1. First Embodiment

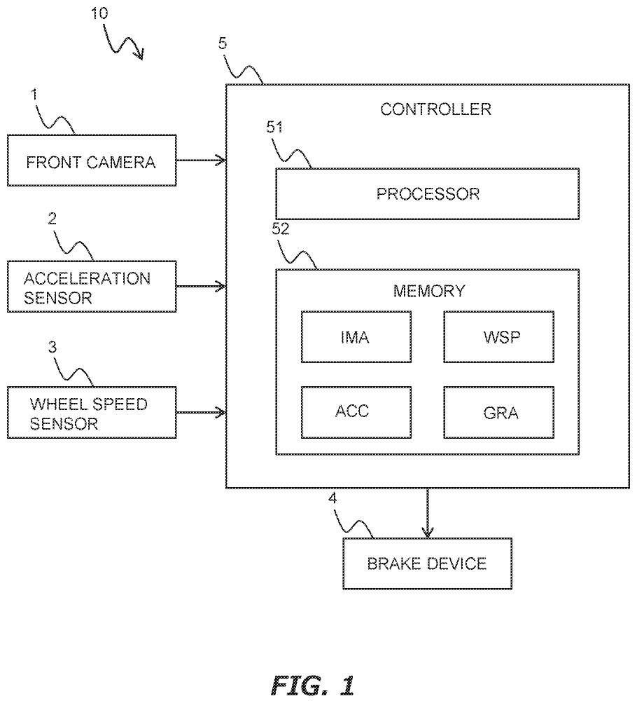

A first embodiment of the present disclosure will he described with reference to FIGS. 1 to 7.

### 1-1. Configuration Example of Vehicle Control System

FIG. 1 is a diagram showing a configuration example of a road surface type estimation device and a vehicle control system according to the first embodiment. A vehicle control system 10 shown in FIG. 1 is mounted on a vehicle VH. The vehicle VH is, for example, a vehicle in which an internal combustion engine such as a diesel engine or a gasoline engine is used as a power source, an electronic vehicle in which an electric motor is used as the power source, or a hybrid vehicle including the internal combustion engine and the electric motor. The electric motor is driven by a battery such as a secondary cell, a hydrogen cell, a metallic fuel cell, and an alcohol fuel cell.

As shown in FIG. 1, the vehicle control system 10 includes a front camera 1, an acceleration sensor 2, a wheel speed sensor 3, a brake device 4, and a controller 5. The road surface type estimation device according to the first embodiment is composed of elements excluding the brake device 4 (i.e., the front camera 1, the acceleration sensor 2, the wheel speed sensor 3 and the controller 5).

The front camera 1 is a digital camera that photographs an image in front of the vehicle VH. The front camera 1, for example, incorporates an image pickup element such as a CCD (Charge Coupled Device) and a CIS (CMOS Image Sensor). The front camera I generates video data (shot image data. IMA) at a predetermined frame rate. The front camera 1 has a wide-angle to lens or a fish-eye lens, and photographs a predetermined range (e.g., a range of 140 to 220 degrees) a horizontal direction. An optical axis of the front camera 1 is set horizontally. The front camera 1 supplies the shot image data IMA to the controller 5.

The acceleration sensor 2 detects acceleration of the vehicle (e.g., lateral acceleration, longitudinal acceleration, and vertical acceleration). The acceleration sensor 2 supplies the controller 5 data of the acceleration as acceleration data ACC.

The wheel speed sensor 3 detects rotation speed per unit time (wheel speed Vw) of respective wheels of the vehicle VH (i.e., a left front wheel, a right front wheel, a left rear wheel and a right rear wheel). The wheel speed sensor 3 supplies to the controller 5 data of the rotational speed as wheel speed data WSP.

The brake device 4 includes, for example, a master cylinder, a wheel cylinder provided in the respective wheels, and a brake actuator. The brake actuator generates brake pressure by supplying a brake fluid from the master cylinder to the wheel cylinder. The brake actuator also has a function to control the braking pressure for each wheel cylinder. An operation of the brake actuator is controlled by the controller 5.

The controller 5 at least includes a processor 51 and a memory 52. The processor 51 executes various processing. Examples of the memory 52 include a volatile memory and a nonvolatile memory. Various data is stored in the memory 52. Various types of data include the shot image data IMA from the front camera 1, the acceleration data ACC from the acceleration sensor 2 and the wheel speed data RVSP from the wheel speed sensor 3.

Various types of data also include gradient data GRA. The gradient data GRA is data indicating gradient ΔG of a road surface (i.e., a traveling road surface) on which the vehicle VH travels. The gradient ΔG is an angle between the traveling road surface and a horizontal plane in a traveling direction of the vehicle VH. The gradient ΔG exhibits zero in a flat road, a positive value in an upward slope, and a negative value in a downward slope. The gradient ΔG is calculated, for example, as a difference between a differential dVx of driving speed Vv and longitudinal acceleration Gx (ΔG=dGx−Gx). The driving speed Vv may be the rotation speed of the slowest wheels of the wheels of the vehicle VH, or may be an average of the rotation speed of all wheels. The longitudinal acceleration Gx is included in the acceleration data ACC.

When the processor 51 executes a control program as a computer program, various processing by the processor 51 (controller 5) is realized. The control program is stored in the memory 52 or recorded on a computer readable recording medium. The various processing include processing to estimate a type of the traveling road surface (road surface type estimation processing), and processing to set an operation mode of the brake device 4 in accordance with the estimated type of the traveling road surface operation mode setting processing). Hereinafter, process functions of the controller 5 will be described.

### 1-2. Configuration Example of Controller

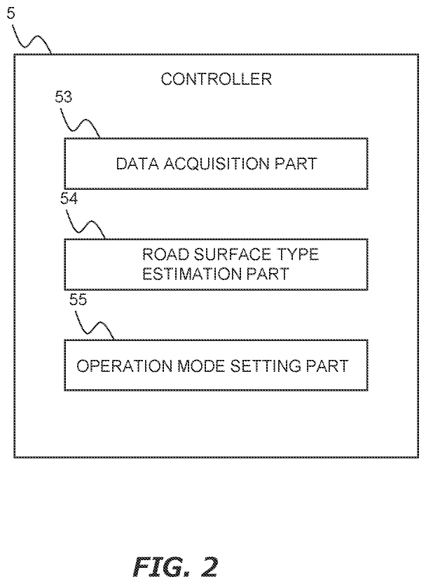

FIG. 2 is a diagram showing a functional configuration example of the controller 5 shown in FIG. 1. In the example shown in FIG. 2, the controller 5 includes a data acquisition part 53, a road surface type estimation part 54 and an operation mode setting part 55.

The data acquisition part 53 obtains various types of data. The various types of data include the shot image data IMA, the acceleration data ACC and the wheel speed data WSP. The various types of data also include the data of the differential values dVx described above and the gradient data GRA calculated based on the differential values dVx. The data acquisition part 53 stores the acquired various types of data in the memory 52.

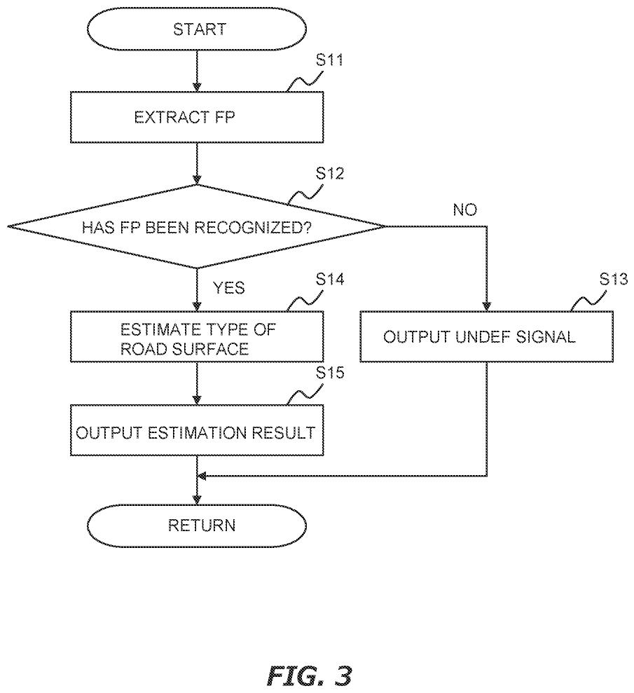

The road surface type estimation part 54 executes road surface type estimation processing. FIG. 3 is a flow chart showing a flow of the road surface type estimation processing. The processing routine shown in FIG. 3 is executed each time as the shot image data IMA supplied from the front camera 1 is stored in the memory 52. For convenience of explanation, it is assumed that the processing routine shown in FIG. 3 is a routine executed in the road surface type estimation processing of m-th time (m≥1).

In the processing routine shown in FIG. 3, first, at least one feature portion is extracted (S11). In the processing of the step S11, for example, a shot image PC composing of the latest shot image data IMA is divided into images of a small area called a patch, and a neural network technology is applied to the patch image. The term “latest” as used herein means just before the execution of the processing of step S11. That is, the latest shot image data IMA means the shot image data IMA that is acquired by the acquisition part 53 just before the execution of the processing of the step S11 in this routine.

Subsequent to the processing of the step S11, it is determined whether or not the feature portion FP has been recognized (step S12). The determination of the step S12 is executed by comparing a threshold R1 with a ratio R of a pixel region of the feature portion FP to full pixel region of the shot image PC. If the ratio R is less than the threshold R1 (e.g., 10%), it is determined that the feature portion FP has not been recognized, and a UNDEF (Undefined) signal is outputted to the operation mode setting part 55 (step S13).

If the ratio R is equal to or larger than the threshold R1 value, it is determined that the feature portion FP has been recognized, and the type of the traveling road surface is estimated (step S14). In the processing of the step S14, well-known machine learning is performed by inputting the feature portion FP that was recognized in the step S11. As a result, the traveling road surface is classified into any one type of road surfaces that were set in advance.

In the first embodiment, as the road surfaces for the classification, a paved road surface and an unpaved road surface are prepared in advance. The unpaved road surface is subdivided into a sandy road surface (Sand), a muddy road surface (Mad) and other bad road surfaces (Other Bad), The signal indicating an estimation result ER (m) at the m-th road surface type estimation processing is outputted to the operation mode setting part 55 (step S15).

Return to FIG. 2 and continue to explain the functional configuration example of the controller 5. The operation mode setting part 55 executes operation mode setting processing. Here, in the first embodiment, automatic braking control (brake traction control) in which brake pressure is changed automatically regardless of an operation of the brake pedal. The automatic braking control is started when an actual slip ratio S is equal to or greater than a threshold S1. The actual slip ratio S is calculated for each wheels based on the wheel speed Vw and the driving speed Vv (e.g., the rotational speed of the slowest wheels of the wheels of the vehicle VH). In the automatic braking control, a target slip ratio η is calculated for each wheels, and the braking pressure is controlled for each wheels based on this target slip ratio η.

The automatic braking control is stopped when the actual slip rate S drops below a threshold S2 value. The threshold S2 is a value less than the threshold S1. That is, in the automatic braking control, the threshold S1 that is a value for starting the control and the threshold S2 that is a value for stopping the control are set different value. The operation mode includes a plurality of operation modes that differ in the threshold S1 and/or threshold S2. The operation mode setting part 55 selects one of the plurality of operation modes based on the signal indicating the estimation result ER(m) from the road surface type estimation part 54.

The plurality of operation modes include an operation mode M1 for the paved road surface, an operation mode M2 for the unpaved road surface, and an operation mode M3 for evacuation traveling. The operation mode M2 includes an operation mode M21 for the sandy road surface, an operation mode M22 for the muddy road surface, and an operation mode M23 for other bad road surfaces. The operation mode M3 is an operation mode when the feature portion FP is not recognized.

For example, the threshold S1 of the operation mode M21, M22 or M23 is set to be a larger value than that of the operation mode M1. For this reason, it is more difficult to start the execution of the automatic braking control while traveling on the unpaved road surface than when traveling on the paved road surface. The threshold S1 of the operation mode M3 is set to be the same value as that of operation mode M1.

For example, the threshold S2 of the operation mode M21 or M22 is set to be a smaller value than that of the operation mode M1. For this reason, it is easier to continue the execution of the automatic braking control while traveling on the sandy road surface or the muddy road surface than when traveling on the paved road surface. The threshold S2 of the operation mode M21 may be set to be a smaller value than that of the operation mode M22. The threshold S2 of the operation mode M23 or the operation mode M3 is set to the same value as that of the operation mode M1.

In the operation mode setting processing, the operation mode is set based on the signal inputted from the road surface type estimation part 54. When the signal indicating the estimation result ER(m) is inputted, the operation mode (i.e., the operation mode M1, M21, M22 or M23) corresponding to the content of the signal estimation result ER(m) is set. When the UNDEF signal is inputted, the operation mode corresponding to this is set (i.e., operation mode M3). When both the signal indicating the estimation result ER (in) and the UNDEF signal are inputted, the operation mode is set according to the content of the former.

### 1-3. Characteristics in First Embodiment

### 1-3-1. Problems During Upward Slope Driving

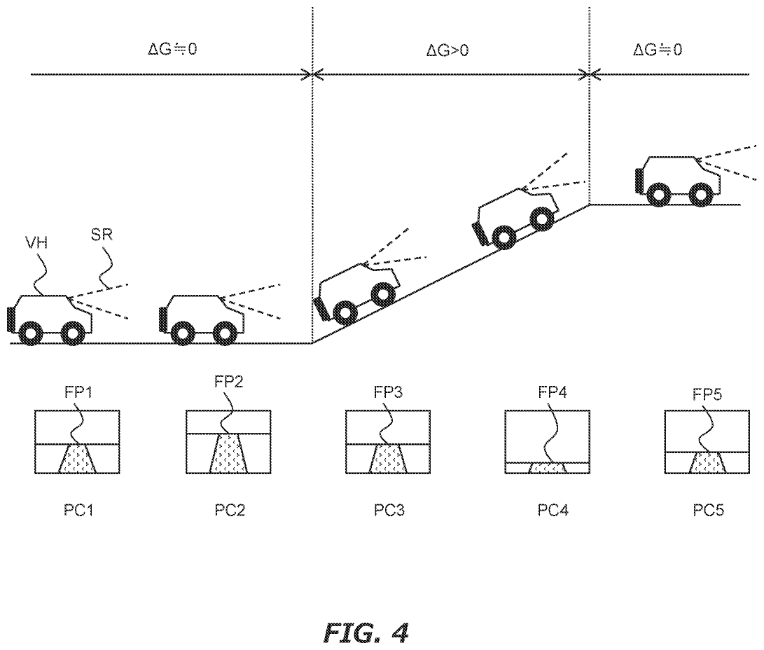

As described above, during the travel on the upward slope, information amount of the traveling road surface taken by the front camera decreases toward the end point of the upward slope. FIG. 4 is a diagram showing an example of the shot image PC during the vehicle VH traveling on a low place flat road (ΔG≈0) reaches a high place flat road (ΔG≈0) via an upward slope (ΔG>0). In the example shown in FIG. 4, the shot images PC1 to PC5 taken at each transit point are depicted. Note that the imaging range SR shown in FIG. 4 indicates the imaging range of the front camera 1 in the vertical direction.

The shot image PC1 corresponds to an example of the image taken on the low place flat road plane remoting from the upward slope. On the other hand, the shot image PC2 corresponds to an example of the image taken on the low place flat road surface in front of the upward slope. In front of the upward slope, an entire of the upward slope is taken by the front camera 1. Therefore, comparing the shot image PC1 and PC2, it can be seen that the area of the pixel region of the feature portion FP2 is larger than that of the feature portion FP1. That is, it can be seen that information amount of the traveling road surface obtained from the shot image PC2 is greater than that obtained from the shot image PC1.

The shot image PC3 corresponds to an example of the image taken beyond a beginning point of the upward slope. On the other hand, the shot image PC4 corresponds to an example of the image taken in front of an end point of the upward slope. As the vehicle VH moves forward on the upward slope, the end point of the upward slope taken by the front camera 1 shifts to a lower area of the shot image. Therefore, comparing the shot images PC3 and PC4, it can be seen that the area of the pixel region of the feature portion FP4 is smaller than that of the feature portion FP3. That is, it can be seen that the information amount of the traveling road surface obtained from the shot image PC4 is less than that obtained from the shot image PC3.

The shot image PC5 corresponds to an example of the image taken during the travel on the high place flat road plane beyond the end point of the upward slope. As the vehicle VH climbs up the upward slope, the front camera 1 captures the road surface locating in front of the vehicle VH. Thus, it can be seen that the information amount of the traveling road surface obtained from the shot image PC5 is greater than that obtained from the shot image PC4.

What is problematic here is that the information amount of the traveling road surface obtained from the shot image PC changes before and after passing through the end point of the upward slope, in particular, when the gradient ΔG of the upward slope is large, the ratio R, which decreases toward the end point of the upward slope (i.e., the ratio of the pixcel region of the feature portion FP to the full pixel region of the shot image PC) may be lower than the threshold R1. Then, in this instance, it is determined by the road surface type estimation processing that the feature portion FP is not recognized on the way to the end point of the upward slope. Then, the operation mode setting processing sets the operation mode M3.

Here, it is assumed that both of the road surface of the upward slope and the type of the high place flat road surface correspond to the unpaved road surface. In this case, the operation mode setting processing changes from the operation mode M2 to the operation mode M3 on the way to the end of the upward slope. Thereafter, the operation mode M3 is changed to the operation mode M2 after the vehicle VH climbs the upward slope. That is, just before the vehicle VH climbing the upward slope, the operation mode M2 is temporarily switched to the operation mode M3. Therefore, a series of this switch in the operation mode can give a driver of the vehicle VH a feeling of strangeness.

As a first measure against this issue, it is conceivable to set the thresholds S1 and S2 of the two type of the operation mode M3 to the same value as that of the operation mode M2. However, the aim of setting the operation mode M3 is to cope with an exceptional case in which the feature portion FP is not recognized. Considering this objective, even though it is an exceptional case, it is not appropriate to simply set the operation mode M2 that is the operation mode for the unpaved road surface.

As a second measure, it is conceivable in this exceptional case to diver previous estimation result of the road surface type. However, it is also assumed that the reason why the feature portion FP is not recognized is a defect including a deviation of the optical axis of the front camera 1. Therefore, it is not appropriate to simply use the previous estimation result from a viewpoint of securing an estimation accuracy of the road surface type.

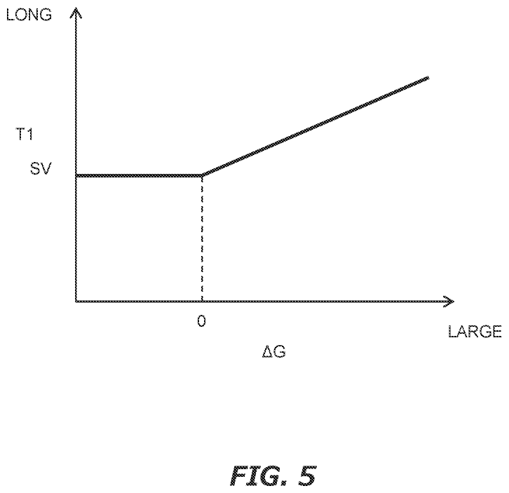

In view of such problems, in the first embodiment, a period T1 during which the estimation result ER(m) is held (hereinafter, also referred to as a “holding time”) is set in accordance with the gradient ΔG of the upward slope. FIG. 5 is a diagram showing a relationship example between the gradient ΔG and the holding time T1. As described above, the gradient ΔG exhibits zero in the flat road, a positive value in the upward slope, and a negative value in the downward slope. In the first embodiment, therefore, the holding time T1 is set to a reference value SV in the downward slope and the flat road. On the other hand, in the upward slope, the holding time T1 is set to a longer period as the gradient ΔG of the upward slope increases.

By setting such the holding time T1, it can be avoided in advance that the operation mode M2 is temporarily switched the operation mode M3 in the exceptional case. In addition, since the holding time T1 is finite, the estimation result ER(m) can be avoided from being diverted in spite of a case of the defect including the deviation of the optical axis of the front camera 1.

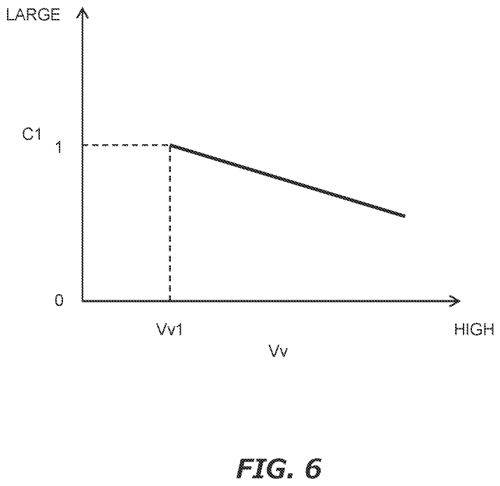

Preferably, the holding time T1 is adjusted as the driving speed Vv. This is because when the vehicle VH travels at a low speed, a situation where the exceptional case continues becomes longer than a situation where the vehicle VH travels at a high speed. FIG. 6 is a diagram showing a relationship example between the driving speed Vv and a correction coefficient C1. The correction coefficient C1 is a coefficient to which the holding time T1 multiplies. In the example shown in FIG. 6, the correction coefficient C1 is set to be the largest value in extremely low speed Vv1 (in the example of FIG. 6 is 1) and decreases as the driving speed Vv increases.

### 1-3-2. Specific Processing Flow

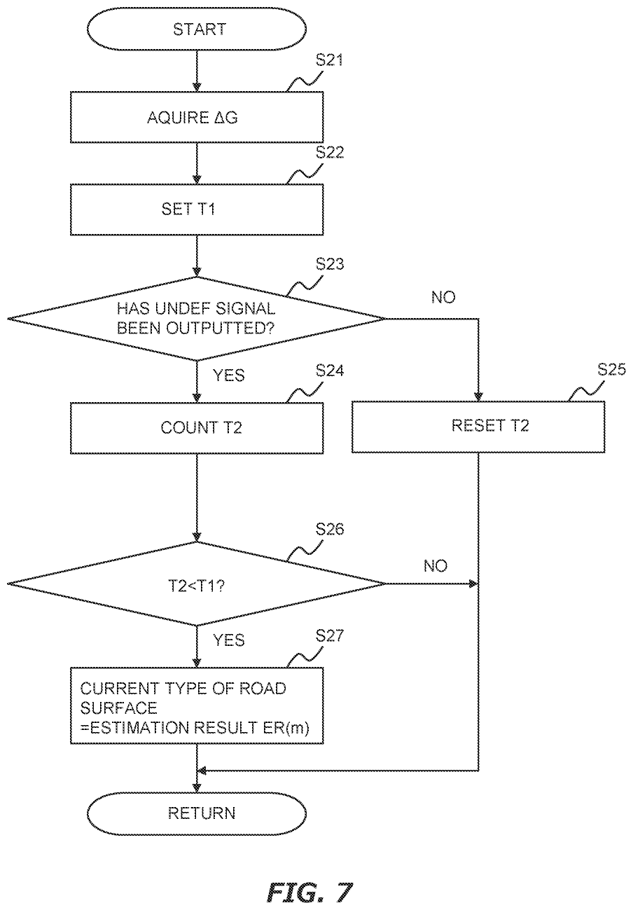

FIG. 7 is a flow chart showing a flow of the road surface estimation processing of (m+n)-th time (m+n≥2). The processing of the routine shown in FIG. 7 is executed in parallel with the execution of the (m+n)-th processing of the routine shown in FIG. 3. For convenience of explanation, it is assumed that the timing of the execution of the (m+n)-th processing is current timing. That is, by executing the (m+n)-th processing shown in FIGS. 3 and 7, the type of the current traveling road surface is estimated.

In the processing routine shown in FIG. 7, first, the gradient ΔG is acquired (step S21). The gradient ΔG is the latest gradient data GRA. The term “latest” as used herein means just before the execution of the processing of the step S21. That is, the latest gradient data GRA means the gradient data GRA that is acquired by the acquisition part 53 just before the execution of the processing of the step S21 in this routine.

Subsequent to the processing of the step S21, the holding time T1 is set (step S22). The setting of the holding time T1 is executed, for example, by applying the gradient ΔG to a control map indicating the relationship described in FIG. 5.

When the driving speed Vv is considered in the holding time T1, the following processing is executed. That is, prior to the execution of the processing of the step S22, the driving speed Vv is calculated from the latest wheel speed data WSP. The term “latest” as used herein means just before the execution of the processing of the step S22. That is, the latest wheel speed data WSP means the wheel speed data WSP that is acquired by the acquisition part 53 just before the execution of the processing of the step S22 in this routine. Subsequently, the driving speed Vv is applied to a control map indicating the relationship described in FIG. 6, and the correction coefficient C1 is set. Then, after the processing of the step S22, the holding time T1 is multiplied by the correction coefficient C1.

Subsequent to the processing of the step S22, it is determined whether or not the UNDEF signal has been outputted (step S23). As described in FIG. 3. if the feature portion FP is not recognized, the UNDEF signal is outputted. In the processing of the step S23, it is determined whether or not the UNDEF signal is outputted in the (m+n)-th processing routine of FIG. 3 that is executed in parallel with the execution of the present processing routine.

If the determination result of the step S23 is positive, a UNDEF duration T2 is counted (step S24). The period UNDEF duration T2 is a period during which it is determined that the UNDEF signal is outputted. That is, the UNDEF duration T2 is a period during which the determination result indicating that the UNDEF signal is outputted continues to he issued in the previous processing of the step S23 including the processing at the (m+n)-th processing routine.

If the determination result of the step S23 is negative, the UNDEF duration T2 is reset (step S25). The UNDEF signal is outputted when it is determined that the feature portion FP is not recognized (see the step S16 of FIG. 3). Therefore, it can be said that type of the traveling road surface can be estimated when the UNDEF signal is not outputted. Thus, the UNDEF duration T2 counting is not required and the UNDEF duration T2 is reset.

Subsequent to the processing of the step S24, it is determined whether or not the UNDEF duration T2 is shorter than the holding time T1 (step S26). If the determination result of the step S26 is negative, the reason why the UNDEF signal is outputted is assumed to be the failure case including the optical axis shift of the front camera 1. Therefore, in this case, the (m+n)-th processing routine is terminated in order to allow the setting of operation mode M3 in response to the output of the UNDEF signal.

If the determination result of the step S26 is positive, it is estimated that type of the present traveling road surface is the same as the estimation result ER (m) (step S27). As mentioned previously, the estimation result ER(m) is the type of the classified traveling road surface when the feature portion FP is recognized in the m-th road surface type estimation processing. When the processing of the step S27 is executed, the current traveling road surface is classified into the paved road surface or unpaved road surface as the estimation result ER(m) (i.e., the sandy, muddy or other bad road surface).

### 1-4. Effect

According to the first embodiment described above, the holding time T1 as a validity period of the estimation result ER (m) is set. In addition, the UNDEF duration T2 is set during which it is determined that the UNDEF signal is continuously outputted. In addition, when it is determined that the UNDEF duration T2 is shorter than the holding time T1 in the (m+n)-th road surface type estimation processing, it is estimated that type of the current traveling road surface is the same as the estimation result ER(m). Therefore, even in the exceptional case where the UNDEF signal is outputted, it is possible to give a proper estimation result on the type of the current traveling road surface.

### 2. Second Embodiment

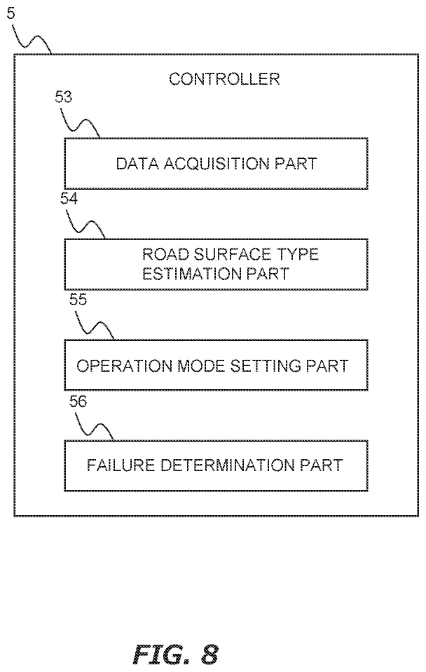

Next, a second embodiment of the present disclosure will be described with reference to FIGS. 8 to 10. Note that descriptions overlapping with the first embodiment are omitted as appropriate.

### 2-1. Configuration Example of Controller

FIG. 8 is a diagram showing a functional configuration example of a road surface type estimation device according to the second embodiment. In the example shown in FIG. 8, the controller 5 includes the data acquisition part 53, the road surface type estimation part 54, the operation mode setting part 55, and a failure determination part 56. Functional configurations other than the failure determination part 56 are described in FIG. 2.

The failure determination part 56 executes failure determination processing of the front camera 1. Examples of the failure of front camera 1 include, in addition to the optical axis shift mentioned above, hardware-related defects such as a contamination of the lens and a breakage. Examples of the failure of the front camera 1 also includes, software-related defects such as generation of noises in the shot image. Processing to detect a generation of such the failure is the failure determination processing. If the failure is detected, the failure determination part 56 outputs a failure signal to the operation mode setting part 55. The failure determination part 56 may issue a notification to the driver based on the failure signal while outputting the failure signal.

In the operation mode setting processing of the second embodiment, the operation mode is set based on the signal inputted from the road surface type estimation part 54 and the failure determination part 56. The operation mode setting method based on the input signal from the road surface type estimation part 54 is as described in the first embodiment. When the failure signal is inputted from the failure determination part 56, the operation mode is set in accordance with the signal indicating the estimation result of the latest traveling road surface. The term “latest” as used herein means just before the failure signal is inputted. That is, the signal indicating the estimation result of the latest traveling road surface means the signal input from the road surface type estimation part 54 to the operation mode setting part 55 just before the failure signal is input. As the signal indicating estimation result of the latest traveling road surface, a signal indicating an estimation result ER (m+n−1) and the UNDEF signal are assumed. When both of these signals are input as the latest signal, it is the same as the first embodiment, the operation mode is set according to the former.

### 2-2. Failure Determination Processing

### 2-2-1. Problems in Failure

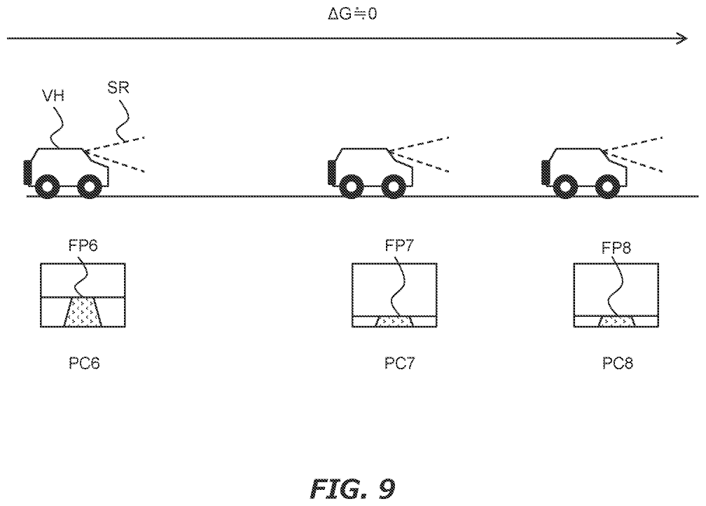

FIG. 9 is a diagram for explaining characteristics of the second embodiment. Similar to the first embodiment, the road surface type recognition processing is executed in the second embodiment. Therefore, when the road surface type recognition processing is executed, the holding time T1 is set and the UNDEF duration T2 is counted as needed.

In the example shown in FIG. 9, the vehicle VH travels on the flat road plane with a gradient ΔG≈0. All shot images PC6 to PC8 correspond to examples of the images taken in this flat road plane. Comparing the shot image PC6 with the shot image PC7 or PC8, it can be seen that the area of the pixel region of the feature portion FP6 is smaller than that of the feature portion FP7 or FP8. That is, it can be seen that the information amount of the traveling road surface obtained from the shot image PC7 or PC8 is less than that obtained from the shot image PC6.

Here, it is assumed that the type of flat road plane corresponds to the unpaved road surface. In this case, the operation mode setting processing should set the operation mode to the operation mode M2. However, when the failure occurs in the front camera 1, the ratio R (i.e., the ratio of the pixel region of the feature portion FP to the full pixel region of the shot image PC) may be lower than the threshold R1. On the other hand, since the gradient ΔG is substantially zero, the holding time T1 that is set according to the gradient ΔG is short. Therefore, there is a possibility in the comparison with the holding time T1 that it is determined that the UNDEF duration T2 is longer than the holding time T1. Then, the operation mode for evacuation traveling (that is, the operation mode M3) is set in the operation mode setting processing.

Here, the first embodiment assumes that the front camera 1 is not defective. Therefore, even if the ratio R is lower than threshold R1 value in the middle of the upward slope, the operation mode corresponding to the type of the original traveling road surface is set by determining that the UNDEF duration T2 is shorter than the holding time T1. Further, after the vehicle VH climbs the upward slope, the ratio R exceeds the threshold R1 value, whereby the operation mode corresponding to the type of the original traveling road surface is set. That is, in the first embodiment, the automatic braking control corresponding to the original traveling road surface (i.e., the unpaved road surface) is executed appropriately.

However, when the generation of the front camera 1 failure is considered, when the ratio R is lower than the threshold R1, it is determined that the UNDEF duration T2 is longer than the holding time T1. Then, there is a possibility that the operation mode corresponding to the type other than the original traveling road surface type will be set. Then, although the original traveling road surface is the unpaved road surface, the automatic, braking control is executed in the same operation mode (i.e., the operation mode M3) as that of the operation mode (i.e., the operation mode M1) corresponding to the paved road surface.

To avoid such the situation, in the second embodiment, when it is determined that the UNDEF duration T2 is longer than holding time T1, the failure determination processing is executed to narrow down its cause.

### 2-2-2. Specific Processing Flow

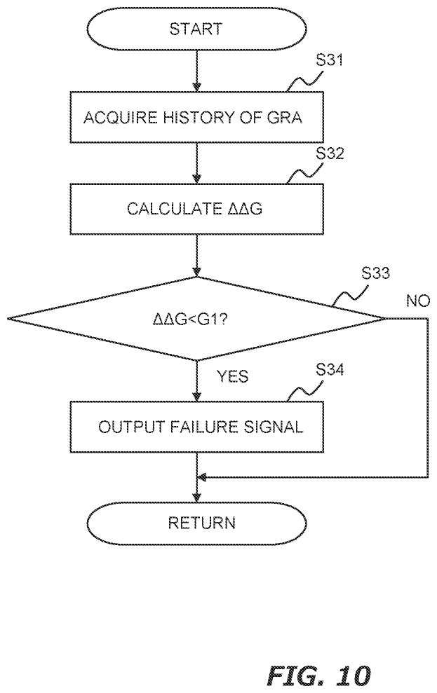

FIG. 10 is a flowchart showing a flow of the failure determination processing. The processing of the routine shown in FIG. 10 is executed when a negative determination result is issued in the processing of the step S26 described in FIG. 7. That is, the processing of the routine shown in FIG. 10 is executed when a certain condition is satisfied when the (m+n)-th processing routine described in FIG. 7 is executed.

In the processing routine shown in FIG. 10, first, a history of the gradient data GRA is acquired (step S31). The history of the gradient data GRA include data group of the gradient ΔG acquired by the data acquisition part 53 during a predetermined time period retroactively prior to the execution of the (m+n)-th processing routine described in FIG. 7.

Subsequent to the processing of the step S31, the rate of change ΔΔG of gradient ΔG is calculated (step S32). In the processing of the step S32, an average of the data group of the gradient ΔG acquired in the processing of the step S31 is calculated. Then, a rate of change ΔΔG is calculated by dividing this average by a predetermined period.

Subsequent to the processing of the step S32, it is determined whether or not the rate of change ΔΔG is smaller than a threshold G1 (step S33). Examples of the threshold G1 include a low change rate of about 5%.

When the result of the determination of the step S33 is negative, it is determined that the reason why the feature portion FP is not recognized is not the failure of the front camera 1. On the other hand, when the result of the determination of the step S33 is positive, it is determined that the reason why the feature portion FP is not recognized is the failure of the front camera 1. Therefore, in the latter case, the failure signal is outputted (step S34).

### 2-3. Effect

According to the second embodiment described above, when it is determined that the UNDEF duration T2 is longer than the holding time T1 in the (m+n)-th road surface type estimation processing, it can be detected that the cause of the feature portion FP not being recognized is the occurrence of the defects including the optical axis deviation of the front camera 1. In addition, the operation mode can be set in accordance with the signal indicating the estimation result of the latest traveling road surface. Therefore, it is possible not only to detect the failure of the front camera 1 but also to give an appropriate estimation result of the traveling road surface with respect to the type of the current traveling road surface even when the failure of the front camera 1 is detected and the UNDEF signal is outputted due to this.

What is claimed is:

1 A road surface type estimation method for estimating a type of a road surface on which a vehicle travels, the method comprising the steps of:
periodically acquiring imaging data in front of the vehicle and gradient data of the road surface; and
repeating to execute estimation processing to estimate the type of the road surface based on the imaging data,
wherein, in m-th time (m≥1) of the estimation processing, a holding time of an estimation result that was obtained in the estimation processing of m-th time is set based on preceding gradient data indicating gradient data acquired just before the execution of the m-th time estimation processing,
wherein the larger an uplink gradient of the road surface indicated by the preceding gradient data, the longer the holding time is set,
wherein, in the estimation processing of (m+n)-th time (m+n≥2),
it is determined whether or not a feature portion has been recognized from the imaging data;
if it is determined that the feature portion has not been recognized, the holding time is compared with an unrecognized duration during which it has been continuously determined that the feature portion was not recognized backward from the execution of the (m+n)-th estimation processing; and
if the holding time is longer than the unrecognized duration, it is presumed that the estimation result in the execution of the (m+n)-th estimation processing is the same as that in the execution of the m-th estimation processing

2 The method according to claim 1,
wherein the method further comprising the step of periodically obtaining a wheel speed data of the vehicle,
wherein, in the m-th estimation processing, as driving speed of the vehicle indicated by the wheel speed data acquired just before the execution of the in-th estimation processing is higher, the holding time that was set based on the uplink gradient is changed to a shorter duration

3 The method according to claim 1,
wherein, in the (m+n)-th estimation processing, if the holding time is shorter than the unrecognized duration, failure determination processing is further executed to determine a failure of a front camera that is configured to acquire the image data periodically,
wherein, in the failure determination processing,
a rate of change in a gradient of the road surface is calculated based on a history of the gradient data that was obtained in a predetermined period backing just before the execution of the (m+n)-th estimation processing; and
if the rate of change is less than a threshold, it is determined that the front camera has failed

4 A road surface type estimation device for estimating a type of a road surface on which a vehicle travels, comprising:
a memory configured to periodically store imaging data in front of the vehicle and gradient data of the road surface; and
a processor configured to execute continuously estimation processing to estimate the type of the road surface based on the imaging data,
wherein, in the estimation processing of m-th time (m≥1), the processor is configured to set a holding tune of an estimation result that was obtained in the m-th estimation processing based on immediately preceding gradient data indicating gradient data stored in the memory just before the execution of the m-th estimation processing,
wherein the larger an uplink gradient of the road surface indicated by the preceding gradient data, the longer the holding time is set,
wherein, in the estimation processing of (m+n)-th time (m+n≥2), the processor is configured to:
determine whether or not a feature portion has been recognized from the imaging data;
if it is determined that the feature portion is not recognized, compere the holding time with an unrecognized duration during which it has been continuously determined that the feature portion was not recognized backward from the execution of the (m+n)-th estimation processing; and
if the holding time is longer than the unrecognized duration, estimate that the estimation result in the execution of the (m+n)-th estimation processing is the same as that in the execution of the m-th estimation processing

5 The device according to claim 4,
wherein the memory further configured to periodically store wheel speed data of the vehicle,
wherein, in the m-th estimation processing, the processor is configured to change the holding time that was set based on the uplink gradient to a shorter duration as driving speed of the vehicle indicated by the wheel speed data acquired just before the execution of the m-th estimation processing is higher

6 The device according to claim 4, further comprising a front camera configured to acquire the imaging data periodically,
wherein, in the (m+n)-th estimation processing, the processor is further configured to execute failure determination processing to determine a failure of the front camera if the holding time is less than the unrecognized duration,
wherein, in the failure determination processing, the processor is configured to:
calculate a rate of change in a gradient of the road surface based on a history of the gradient data that was obtained in a predetermined period just before the execution of the (m+n)-th estimation processing; and
if the rate of change is less than a threshold, determine that the front camera has failed

7 A vehicle control system comprising the road surface type estimation device according to claim 4,
wherein the system further comprising a brake device configured to apply a braking force to wheels of the vehicle,
wherein the processor is further configured to switch an operation mode of the brake device among a plurality of preset operation modes in accordance with the estimation result that was obtained in the (m+n)-th estimation processing
